(19) United States
(12) Patent Application Publication
(10) Pub. No.: US 2018/0354348 A1
(43) Pub. Date: Dec. 13, 2018

(54) SELF-TINTING VEHICLE WINDOW

(71) Applicant: Jordan Cantley, Andrews, SC (US)

(72) Inventor: Jordan Cantley, Andrews, SC (US)

(21) Appl. No.: 15/616,160

(22) Filed: Jun. 7, 2017

(51) Int. Cl. B60J 3/04; G02F 1/01

(52) U.S. Cl. CPC B60J 3/04; G02F 1/0126

(57) ABSTRACT

A self-tinting vehicle window is provided that in some embodiments utilizes photochromic molecules to absorb and filter out light, thereby automatically tinting one or more of a vehicle's windows.

### CROSS-REFERENCE TO RELATED APPLICATION

Not applicable.

### TECHNICAL FIELD

The present invention relates generally to the field of glass for use on vehicles and more specifically relates to self-tinting or “transitional” windows for windshields and windows of vehicles, similar to the material that is available for prescription eyeglasses structured and arranged to allow the user to drive safer during the day without their vision being impaired by the glare of bright sunshine and at night enjoy excellent visibility.

### BACKGROUND

A multitude of drivers like having tinted windows on their vehicles for many reasons. One reason may be that with tinted windows, the hot rays of the sun are blocked so the vehicle stays cooler. Or, tinted windows provide protection from the harsh glare of sunshine to make driving easier on the eyes of the drivers and their passengers. However, at nighttime, these tinted windows can present very real problems, such diminishing a driver's nighttime driving visibility because of the window's tint. Additionally, because most after-market tinting processes usually involve adding a film to the windows that degrades, bubble, and peels off over time, windows tinted in this manner can present many problems as well. Therefore, a need exists for vehicle glass for use on vehicle windows and windshields that provides tinting from the bright sun, but that also does not reduce driver visibility in low light conditions such as at night.

Various attempts to solve this problem have been made. One such attempt can be seen with respect to U.S. Patent Application Publication No. 2009/0027759, incorporated by reference in its entirety herein, which generally discloses a vehicle glass tinting system wherein particles within the glass are activated to transform and cause the glass to be tinted when stimulated by light-sensing electrodes. While this disclosure does provide for vehicle glass wherein the darkness of the tint is precisely matched to the current sunlight conditions, this disclosure relies on complicated sensors and elaborate compositions of suspended particles and window surface treatments.

Another attempt can be seen with respect to U.S. Patent Application Publication No. 2011/0163866, incorporated by reference in its entirety herein, which generally discloses a system wherein a plurality of LCD zones are laminated onto a car's windows, and which are selectively activated based on the presence of an occupant, the direction, location, and rate of travel of the vehicle in comparison with the sun's location. While indeed providing for personalized and presumably effective window tinting, this disclosure again relies on complicated computer sensors to meet the very-difficult-to-calculate problem of sun exposure in real time.

Yet another attempt can be seen with respect to U.S. Pat. No. 6,420,036, incorporated by reference in its entirety herein, which generally discloses electrochromic polymer films, wherein the film utilizes an electrochromic medium to filter light as it passes through the medium. While this disclosure does provide for a sophisticated chemical answer to the problem of self-tinting auto glass, it requires two glass substrates and various layers to work, therefore increasing its cost to both install and repair.

Various attempts have been made to solve the problems which may be found in the related art but have thus far been unsuccessful. A need exists for a self-tinting vehicle window to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

The present invention relates to a self-tinting vehicle window that overcomes the deficiencies of the prior art. It is contemplated that the present invention may provide shade or reduced light to drivers or passengers of a car when appropriate.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel self-tinting vehicle window. The general purpose of the present invention, which will be described subsequently in greater detail, is to provide one or more pieces of a self-tinting vehicle window that enables a user to drive safely or ride peacefully in a car. The features of the invention which are believed to be novel are particularly pointed out and distinctly claimed in the concluding portion of the specification. These and other features, aspects, and advantages of the present invention will become better understood with reference to the following drawings and detailed description.

In one embodiment, the present invention may provide for a self-tinting vehicle window. In some embodiments, the present invention may provide for one or more pieces of glass or polycarbonate material that have been treated with photochromic molecules, organic photochromic molecules, or molecules or materials having equivalent properties or function (collectively, the “treatment”) that change shape and absorb ultraviolet light when exposed to sunlight, thereby providing tint. In some embodiments, the treatment utilized by the present invention may provide that the glass or polycarbonate is coated with silver chloride or silver halide, or impregnated with these or other photosensitive compounds. The present invention may provide that in some embodiments, the treatment, impregnation, or otherwise application of the aforementioned molecules and compounds may be done in such a way that at their maximum absorption, that is at their maximum shape-change and light-absorption, that enough light passes through untreated portions of the glass or polycarbonate that the driver or other user remains safe and proper visibility is maintained.

In some embodiments, the treatment afore-mentioned treatment may cover part of a window or the entirety of the window. In some embodiments, the treatment may be impregnated within the glass or polycarbonate, applied on a layer on a surface of the glass or polycarbonate, or both. In some embodiments, an alternate material may be applied that may be activated by an electrical or other impulse from a sensor, an electrochemical reaction, or both.

The present invention may provide for a way to provide tinted windows that adjust to the amount of sunlight that is present. It will turn the glass or polycarbonate darker when the bright sun's rays hit the glass. The window will not be darker than what is allowed by the traffic laws in the state where the vehicle is operated. As the sun goes down and disappears, the window reacts to reduced sunlight by becoming clearer, so full visibility at night is possible.

The unique features of this invention will provide the following benefits for all consumers: the vehicle window will darken in bright sunshine, keeping the vehicle cooler and making driving easier on the eyes; the shaded windows will change to clear at night, so driving visibility is not limited; it will provide a maintenance-free way to enjoy the benefits of having shaded windows when the sun is bright; and the level of tint adjusts automatically to the amount of light available so driver safety is not impaired.

### BRIEF DESCRIPTION OF THE DRAWINGS

These and other features, aspects and advantages of the present invention will become better understood with regard to the following description, appended claims, and accompanying figures where:

FIG. 1 shows a perspective view of a self-tinting vehicle window in accordance with one embodiment of the invention.

FIG. 2 shows a perspective view of a self-tinting vehicle window in accordance with one embodiment of the invention.

FIG. 3 shows an exploded view of a self-tinting vehicle window in accordance with one embodiment of the invention.

### DETAILED DESCRIPTION

The present invention overcomes the limitations of the prior art by providing a new and more effective self-tinting vehicle window.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

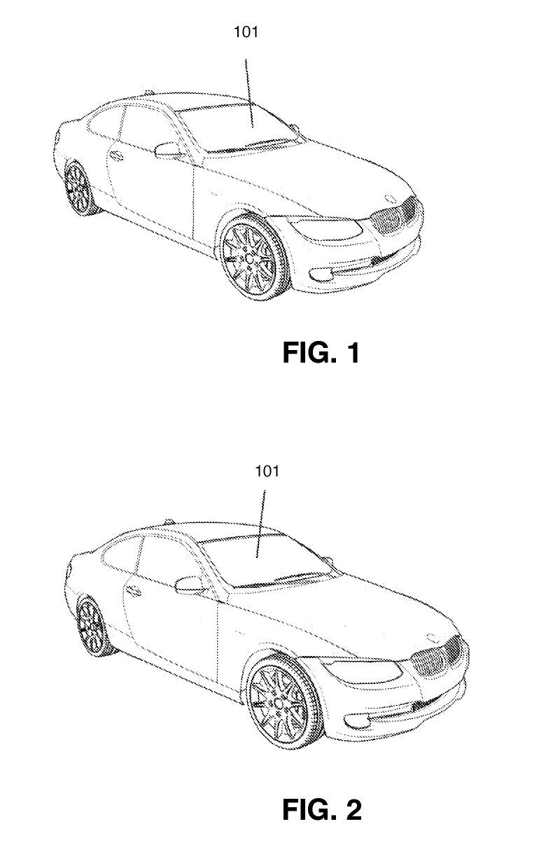

Turning attention to FIG. 1, a perspective view of a self-tinting vehicle window in accordance with one embodiment of the invention is shown. In the embodiment depicted, a viewer may perceive polycarbonate material 101 that tints darker and darker as more and more light strikes it.

With respect to FIG. 2, a perspective view of a self-tinting vehicle window in accordance with one embodiment of the invention is shown. In the embodiment depicted, a viewer may again perceive polycarbonate material 101 that tints darker and darker as more and more light strikes it.

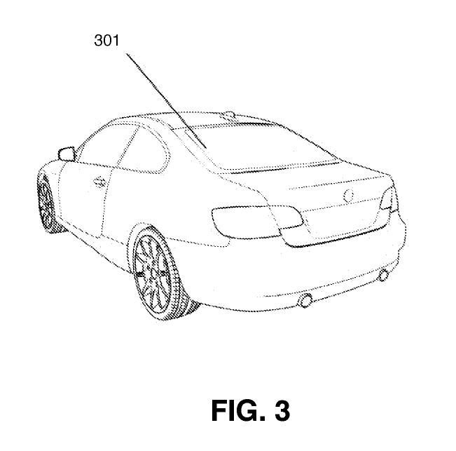

With respect to FIG. 3, a perspective view of a self-tinting vehicle window in accordance with one embodiment of the invention is shown. In the embodiment depicted, a viewer may perceive rear window polycarbonate material 301 that tints darker and darker as more and more light strikes it.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the self-tinting auto window generally described herein has been disclosed in connection with a number of embodiments shown and described in detail, various modifications should be readily apparent to those of skill in the art.

What is claimed is:

1. A self-tinting auto window, comprising:
a window; and
a treatment applied to the window.

2. The window of claim 1, wherein the treatment comprises photochromic molecules.

3. The window of claim 2, wherein the treatment is applied to the surface of the window.

4. The window of claim 2, wherein the treatment is impregnated within the window.

5. The window of claim 1, wherein the treatment comprises organic photochromic molecules.

6. The window of claim 5, wherein the treatment is applied to the surface of the window.

7. The window of claim 5, wherein the treatment is impregnated within the window.

8. The window of claim 1, wherein the window is glass.

9. The window of claim 1, wherein the window is polycarbonate material.

10. The window of claim 9, wherein the treatment comprises photochromic molecules.

11. The window of claim 10, wherein the treatment is applied to the surface of the window.

12. The window of claim 10, wherein the treatment is impregnated within the window.

13. The window of claim 9, wherein the treatment comprises organic photochromic molecules.

14. The window of claim 13, wherein the treatment is applied to the surface of the window.

15. The window of claim 13, wherein the treatment is impregnated within the window.
